(19) United States
(12) Patent Application Publication
(10) Pub. No.: US 2009/0313183 A1
(43) Pub. Date: Dec. 17, 2009

(54) METHOD OF REDUCING PRODUCT DISTRIBUTION COSTS

(76) Inventor: James H. Johnson, JR., Lexington, KY (US)

Correspondence Address: KING & SCHICKLI, PLLC, 247 NORTH BROADWAY, LEXINGTON, KY, 40507, US

(21) Appl. No.: 11/996,665

(22) PCT Filed: Jul. 24, 2006
(86) PCT No.: PCT/US06/28571

§ 371 Date: Jan. 24, 2008

Related U.S. Application Data
(60) Provisional application No. 60/702,476, filed on Jul. 26, 2005.
(60) Provisional application No. 60/771,371, filed on Feb. 8, 2006.
(60) Provisional application No. 60/781,646, filed on Mar. 13, 2006.

(51) Int. Cl. G06Q 90/00

(52) U.S. Cl. 705/500

(57) ABSTRACT

A method for reducing product distribution costs includes the steps of acquiring a site placement right for a product staging structure from a retailer of the product, placing a product staging structure at the site, storing product in the product staging structure and reducing product distribution costs by delivering more product to the retailer during each delivery trip.

This application claims the benefit of U.S. provisional patent applications Ser. Nos. 60/702,476 filed 26 Jul. 2005, 60/771,371 filed 8 Feb. 2006 and 60/781,646 filed 13 Mar. 2006.

### TECHNICAL FIELD

The present invention relates generally to the storage and outdoor advertising fields and more particularly to a method for staging product and reducing product distribution costs.

### BACKGROUND OF THE INVENTION

Many product vendors including particularly but not exclusively limited to dairy and beverage vendors must provide just-in-time delivery services to their high demand retail customers. Typically those retail customers require daily or every other day delivery of products such as milk, beer, soft drinks and sport drinks. It is a significant management challenge to design and develop an efficient delivery schedule to meet retailer demand. Further, transportation costs have recently spiked due to increases in gasoline and diesel fuel prices. [symbol] to rise and therefore delivery costs will trend higher.

The present invention relates to a method for staging product wherein transportation and manpower costs may be reduced dramatically by staging inventory on site at retailer locations. Such an approach also simplifies the development and coordination of delivery schedules.

### SUMMARY OF THE INVENTION

In accordance with the purposes of the present invention as described herein, a method is provided for staging product and reducing product distribution costs. The method comprises placing a product staging structure adjacent a retailer of the product, storing product in the product staging structure and reducing product distribution costs by delivering more product to the retailer during each delivery trip.

The method may further include acquiring a site placement right for the product staging structure from the retailer. In addition, the method may include the marketing of advertising space on the product staging structure. An additional, optional step is the sharing of revenue generated by the marketing of advertising space with the retailer. Still further, the method may include the step of marketing the product on the product staging structure and/or providing the retailer with advertising space on the product staging structure. Still [symbol] transferred from the product staging structure.

In the following description there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of this specification, illustrates several aspects of the present invention, and together with the description serves to explain certain principles of the invention. In the drawing:

FIG. 1 is a perspective view of a storage structure provided to a customer through the method of the present invention; and

FIG. 2 is a schematical end elevational view of a storage structure through the open end doors.

Reference will now be made in detail to the present preferred embodiment of the invention, an example of which is illustrated in the accompanying drawing.

[symbol]

As noted above, the present method relates to reducing product distribution costs. That method may be generally and broadly described as including the steps of placing a product staging structure adjacent a retailer for the product. In addition, the method includes storing product to be sold by the retailer in the staging structure and reducing product distribution costs by delivering more product to the retailer during each delivery trip. This allows one to reduce the overall number of trips necessary to keep the retailer fully stocked in the product for a given period of time. That equates to significant cost savings.

The method may also include the step of acquiring a site placement right from the retailer for the product staging structure. Still further, the method includes marketing advertising space on the product staging structure. The method also includes the step of restocking the retailer with product taken or transferred from the product staging structure. The method may also include many additional steps in numerous combinations and permutations. Those additional steps include sharing revenue generated by the marketing of advertising space with the retailer and/or marketing the product on the product staging structure. Additionally, the method may include providing the retailer with advertising space on the product staging structure. Since the present method provides the product vendor with the ability to maintain a larger onsite product inventory, the number of delivery trips is reduced. As a consequence, [symbol] retailer are significantly reduced and the savings may be substantial.

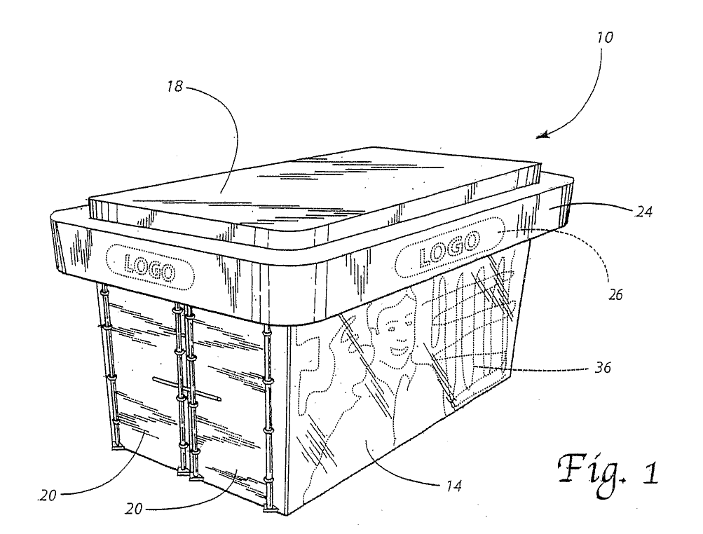

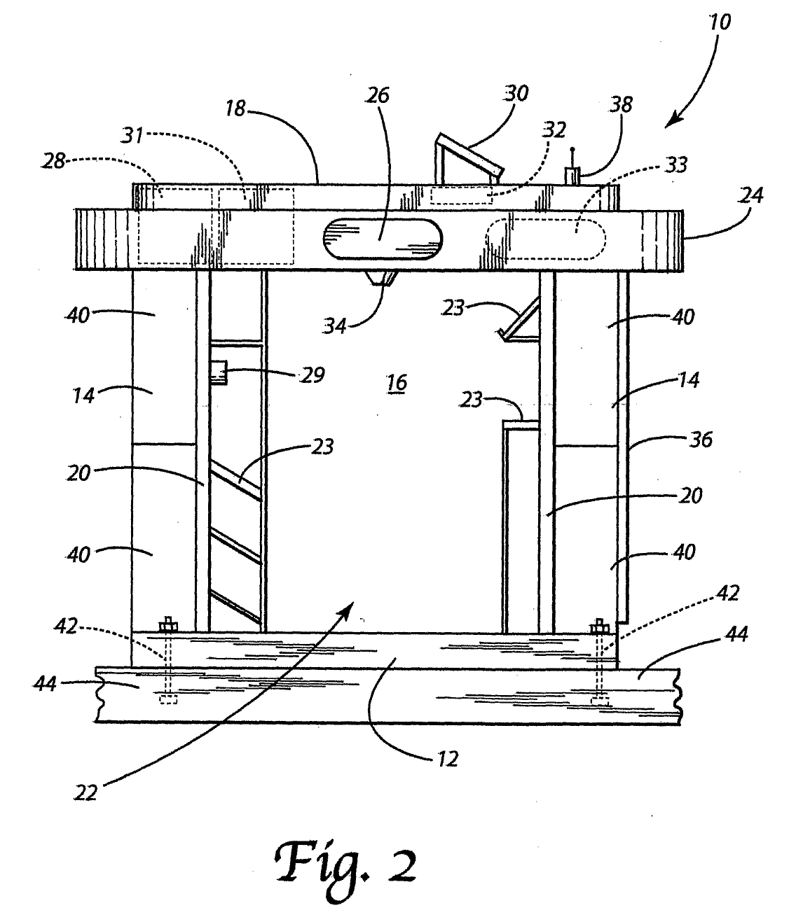

One possible construction of a storage/staging structure a/k/a integrated advertising and storage structure or outbuilding 10 is illustrated in FIGS. 1-2. More specifically the storage structure 10 includes a floor 12, two side walls 14, an end wall 16 and a roof 18. A pair of cooperating, locking doors 20 define a second end wall opposite the first end wall 16. Any type of door 20 useful for the intended purpose may be utilized. Together, the floor 12, side walls 14, end walls 16, roof 18 and doors 20 define an interior storage space 22. That storage space 22 may be customized to meet the vendor's needs including particular rack, shelving, partitioning layouts (note shelves 23) as required or desired by the vendor for purposes of inventory storage and control. The interior customization may, of course, be tailored to integrate with inventory control technology such as bar coding.

Similarly, the exterior of the storage structure 10 may be customized to match the trade dress and/or architectural features of the retailer's main building near which the storage structure 10 may be placed into service. Thus, for example, the storage structure 10 may include a decorative roof cap 24 sized and shaped to customer specifications. The roof cap 24 may include customer advertising, trade dress or logo 26 if desired and/or as allowed by local regulations. [symbol] and/or mechanical systems. For example, a climate control unit such as an air conditioner, refrigerator, freezer, humidifier or dehumidifier 28 may be provided on the storage structure 10 in order to provide climate control of the storage space 22 within the storage structure. Accordingly, products such as perishable food, dairy products, soft drinks and beer may be maintained at the desired temperatures even in hot and humid environments.

In addition, the storage structure 10 may be equipped with a solar panel 30 and cooperating battery 32 to store energy for powering an internal lighting system 34 for illuminating the storage space 22 or illuminating advertising 36 on the side wall 14, end wall 16 or other exterior component of the storage structure 10. That advertising 36 may comprise a stretched banner material and it may be front lit or back lit as desired. If desired, power for all the electrical and mechanical components of the storage structure 10 may be provided through an electrical circuit box 29 carried on the housing 10 and connected to the lines of the local electric utility supplier. Alternatively, the housing 10 may carry an electric generator 31. In one possible embodiment, the generator 31 may be driven by natural gas and connected to the underground supply line of the local natural gas provider. In another possible embodiment, the generator 31 may be driven by propane and the structure may further include a propane storage tank 33 for supplying propane to the generator. Of course, that propane [symbol] the electric generator is powered by a fuel cell.

Still further, the storage structure 10 may incorporate a radio transmitter 38 for the transmission of short range advertisements respecting products displayed in the advertising 36 appearing on the exterior surface of the storage structure 10. A particularly effective advertising combination is the use of a backlit digital graphic advertising banner 36 in conjunction with local transmission radio advertising providing details of the particular product. This is particularly effective when advertising a product that is sold at the customer's place of business.

The storage structure 10 may be constructed from any appropriate material. The storage structure 10 could be constructed in the manner of a standard trailer or box truck and may or may not include additional architectural details. The storage structure 10 may be constructed, for example, from modular building materials such as prefabricated panels 40 of the type shown and described in, for example, U.S. Pat. Nos. 6,279,287 to Meadows, 5,373,678 to Hesser and 6,119,427 to Wyman et al. Such modular panels typically incorporate a core of thermal insulating material sandwiched between metal or plastic sheathing. Such a construction provides both efficient and effective control of the temperature and humidity of the environment in the internal storage space 22 and excellent inclement weather durability for a long, low-maintenance service life. [symbol] characterized by high strength and will resist high winds and maintain a weather-tight enclosure to protect products held in the storage space 22 from inclement weather. In fact, such structures may be easily anchored to the ground such as by means of cooperating nut and bolt anchors 42 where the bolt is held in an underlying poured concrete pad 44. The modular panels 40 also allow the storage structure 10 to be quickly and easily erected and subsequently removed in a minimal amount of time while producing a minimum of mess.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, the advertising 36 may comprise the direct application of graphics to the panels 40 of the structure 10 and down lighting from a light source 42 in the roof cap 24 to illuminate those graphics. The structure 10 could also include an electronic display system such as a plasma monitor, a liquid crystal display, a rotating sign assembly such as disclosed in U.S. Pat. No. 4,021,946, and an electronic message board or the like to display advertising 36.

The embodiment was chosen and described to provide the best illustration of the principles of the invention and its practical application to thereby enable one of ordinary skill in the art to utilize the invention in various [symbol] contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A method of reducing distribution costs relating to sale of a product, comprising:
placing a product staging structure adjacent a retailer of said product;
storing said product in said product staging structure; and
reducing product distribution costs by delivering more product for said retailer during each delivery trip.

2. The method of claim 1 including acquiring a site placement right for said product staging structure from said retailer.

3. The method of claim 1 including marketing advertising space on said product staging structure.

4. The method of claim 3, including sharing revenue generated by said marketing of advertising space with said retailer. [symbol] staging structure.

6. The method of claim 1, including providing said retailer with advertising space on said product staging structure.

7. The method of claim 1, including restocking said retailer with product transferred from said product staging structure.
